(19) United States
(12) Patent Application Publication
(10) Pub. No.: US 2006/0294315 A1
(43) Pub. Date: Dec. 28, 2006

(54) Object-based pre-fetching Mechanism for disc drives

(75) Inventors: Sami Iren, Pittsburgh, PA (US); Wilson Massey Fish, Yukon, OK (US); Qiong Zhang, Oklahoma City, OK (US)

Correspondence Address: PIETRAGALLO, BOSICK & GORDON LLP, ONE OXFORD CENTRE, 38TH FLOOR, 301 GRANT STREET, PITTSBURGH, PA, 15219-6404, US

(73) Assignee: Seagate Technology LLC, Scotts Valley, CA (US)

(21) Appl. No.: 11/167,550

(22) Filed: Jun. 27, 2005

(51) Int. Cl. G06F 13/00; G06F 12/00

(52) U.S. Cl. 711/137; 711/112

(57) ABSTRACT

A method comprises: storing data for a plurality of objects in a plurality of physical blocks on a storage medium, using information about the objects to identify logical addresses for the physical blocks used to store the data, pre-fetching the data from particular ones of the physical blocks based on the identified logical addresses, and storing the pre-fetched data in a memory. Apparatus that performs the method is also included.

### FIELD OF THE INVENTION

This invention relates to data storage devices, and more particularly to pre-fetching mechanisms in such devices.

### BACKGROUND OF THE INVENTION

In disc drive data storage devices, disc performance is greatly affected by seek and rotational latencies. Therefore, modern disc drives come with a certain amount of cache (memory) to improve the speed of the drives. By using a pre-fetching technique, disc drives read data from the media “ahead of time” before the actual request for the data arrives at the drive. When the request arrives, the data is available in the cache and no disc access is required, greatly improving the drive performance and its responsiveness.

The method of predicting the next piece of data to be requested by a user is critical to the performance of the pre-fetch technique. If the wrong piece of data is pre-fetched from the disc, the information in the cache will be useless and a new disc access will be necessary for the new request. Since the disc drive does not know where the pieces of a file are physically located on the disc, it assumes that the next physical sector (block) on the media will be read next and pre-fetches the next N number of sectors (blocks). Unfortunately, this is only effective when related data (i.e., data that is read from the disc in a sequence) are stored in consecutive sectors. However in practice, related data (especially if they are from different files) may not be stored on consecutive sectors.

Object-based storage device (OSD) technology is being developed at the disc drive level. OSD access by a host differs from standard block oriented protocols in a profound way. Data are addressed as objects, and the smallest addressable unit in an OSD disc drive is a byte. Additionally, a significant portion of the file system is abstracted within the disc drive. The physical location and organization of data is hidden from the host and is managed by the disc drive unit.

Object-based storage is an extension of the small computer system interface (SCSI) command set. The object-based storage command set shifts or delegates more functionality and intelligence from the host into the individual storage devices. It does this by managing and storing a file and its metadata together as one coherent object, maintaining the connection down to the object-based storage device level (for example, a controller, a disc array, or an individual disc drive).

Higher level infrastructure activities are delegated to the lowest-level devices, decreasing traffic and enabling new functionality that software alone cannot provide. This enables greater scalability and performance, dynamic reconfiguration, host interoperability, native security, and enhanced reliability.

An object-based storage device can be a network-attached storage device that presents an interface of arbitrarily-named data objects of variable size, rather than sequentially numbered fixed-size blocks, to deal with the data storage details, such as request scheduling and data layout. Metadata can be managed separately by one or more specialized metadata servers. The separation of data and metadata storage and management provides very high access bandwidth to large-scale distributed storage systems.

The OSD architecture treats storage neither as blocks nor files, but as objects. For example, an object could be a single database record, or table, or an entire database. An object may contain a file, or just a portion of a file. The storage device is aware of this content and can handle the lower-level details of device management, like block allocation.

It would be desirable to provide a pre-fetching technique that can be used in object-based storage devices.

### SUMMARY OF THE INVENTION

This invention provides a method comprising: storing data for a plurality of objects in a plurality of physical blocks on a storage medium, using information about the objects to identify logical addresses for the physical blocks used to store the data, pre-fetching the data from particular ones of the physical blocks based on the identified logical addresses, and storing the pre-fetched data in a memory.

In another aspect, the invention provides a method comprising: storing data for a plurality of objects in a plurality of physical blocks on a storage medium, observing behavior of the objects to determine relationships between the objects, using the relationships between the objects to pre-fetch the data from particular ones of the physical blocks, and storing the pre-fetched data in a memory.

The invention also provides an apparatus comprising: a storage medium for storing data for a plurality of objects in a plurality of physical blocks, an arm for positioning a recording head adjacent to the storage medium, a controller for using information about the objects to identify logical addresses for the physical blocks used to store the data, and for pre-fetching the data from particular ones of the physical blocks based on the identified logical addresses, and a memory for storing the pre-fetched data.

The invention further provides an apparatus comprising: a storage medium for storing data for a plurality of objects in a plurality of physical blocks, an arm for positioning a recording head adjacent to the storage medium, a controller for observing behavior of the objects to determine relationships between the objects, and for using the relationships between the objects, or between different portions of the same object, to pre-fetch the data from particular ones of the physical blocks, and a memory for storing the pre-fetched data.

In another aspect, the invention provides a method comprising: using attributes or temporal locality to determine that two or more objects are related and will likely be accessed in sequence; and writing data for the objects to a storage medium in such a way that a traditional pre-fetch operation will pre-fetch the data from the objects using a single read.

### BRIEF DESCRIPTION OF THE DRAWINGS

FIG. 1 is a pictorial representation of the mechanical portion of a disc drive 10 that can be constructed in accordance with the invention.

FIG. 2 is a block diagram of a system including a disc drive constructed in accordance with the present invention.

FIG. 3 is a block diagram of an object-based storage system.

FIG. 4 is a block diagram of portions of firmware in a disc drive controller.

FIG. 5 is a schematic representation of a disc and an associated file.

### DETAILED DESCRIPTION OF THE INVENTION

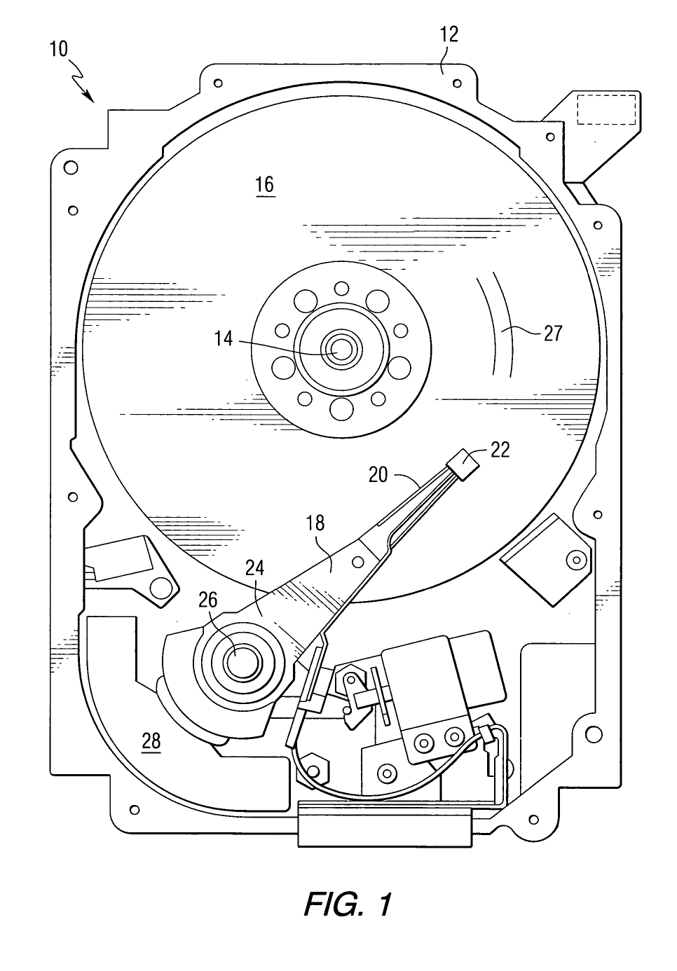

Referring to the drawings, FIG. 1 is a pictorial representation of the mechanical portion of a disc drive 10 that can be constructed in accordance with the invention. The disc drive includes a housing 12 (with the upper portion removed and the lower portion visible in this view) sized and configured to contain the various components of the disc drive. The disc drive includes a spindle motor 14 for rotating at least one data storage medium 16 within the housing, in this case a magnetic disc. At least one arm 18 is contained within the housing 12, with each arm 18 having a first end 20 with a recording and/or reading head or slider 22, and a second end 24 pivotally mounted on a shaft by a bearing 26. An actuator motor, which may be a voice coil motor 28, is located at the arm's second end 24, for pivoting the arm 18 to position the head 22 to a desired position. The actuator motor 28 is controlled by a controller that is not shown in this view. Data and servo information is contained in a plurality of tracks 27.

This invention provides an object-based pre-fetching mechanism for disc drives to pre-fetch data based on a next logical block of an object rather than the next physical disc block. The next logical block is the piece of data that should be read next regardless of where it is located on the disc. For example, if a movie file is considered as an object and the current position is time T of the movie, the next logical block is the piece of data that represents time T+1 regardless of where this piece of data is stored on the disc. A more sophisticated example would be the scenario where the above object (the movie) is fast forwarded. In this case, the next logical block from the current position would be the data block that contains the next I-frame (where I-frames are images that represent synchronization points in the MPEG video file format).

An object is a logical unit (i.e., collection of bytes) of storage that can be accessed using well-known, file-like access methods (e.g., read, write) and includes attributes describing the characteristics of the object. The attributes can be user defined, and can include, for example, an indication of the file type, an indication of a relationship with other objects, an indication of a preferred order of retrieval, a typical access pattern for the object (e.g., sequential vs. random, read-only vs. read-write, request size), an indication of the internal fields of the object and the order in which the fields are accessed, etc. Attributes are stored as part of the object and its metadata. They can be either set during the creation of the object or after the creation via the attributes access mechanism provided by OSD.

An object-based storage device performs the low-level storage functions previously handled at the system-level (i.e., the file system). An OSD disc drive is responsible for all the space management functions at the drive level. Since it manages space, the drive knows what objects (files) are stored on the drive and exactly where the pieces of the objects (files) are located on the drive.

This invention utilizes the space management information available at the disc level, as well as object attributes, to do smart pre-fetching of data from the disc and making the data available for the users in the cache ahead of time. The overall result is improved drive performance and responsiveness.

The object-based pre-fetching mechanism utilizes information about the objects when reading data from the disc ahead of time. Instead of reading data from the next consecutive physical blocks (sectors), it reads data from the next logical block in the object (file) wherever that block might physically be located on the disc. The next logical block could be simply the subsequent bytes inside the object. In the more sophisticated case, the next logical block might be identified based on prior usage and/or other related information that is provided by the application via object attributes. An example of the latter case is the playing back vs. fast-forwarding of a video object as described above. With this scheme, the drive has a much better chance of predicting what the user is going to read next and hence making the right data available in the cache for the next request. The overall disc performance and responsiveness will improve as a result of this scheme.

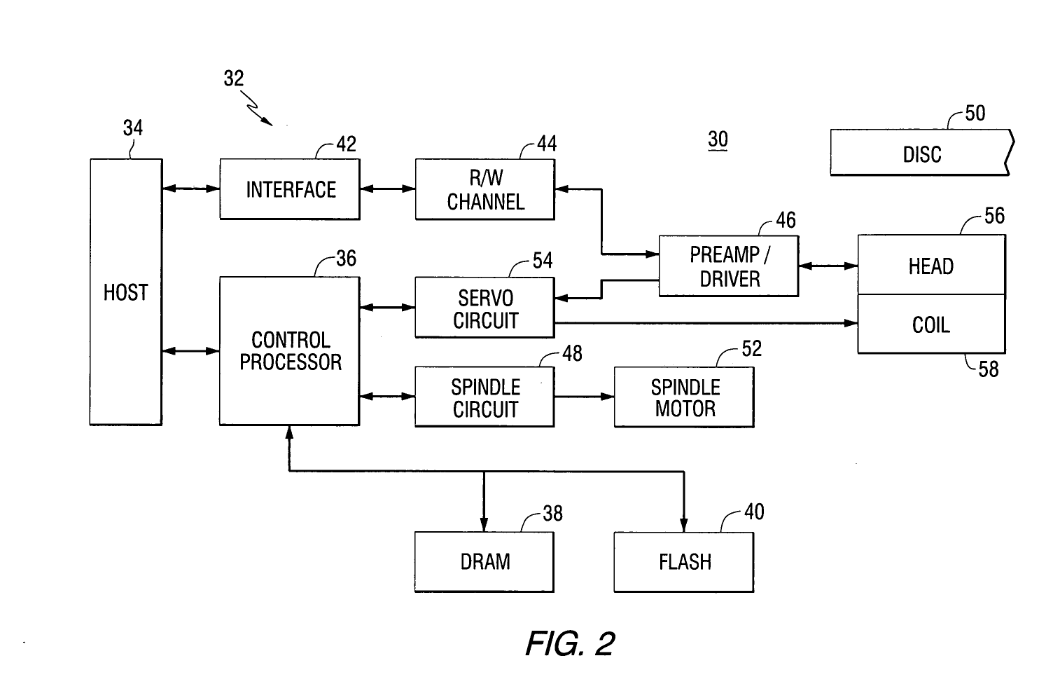

A functional block diagram of an object-based storage system, including a disc drive 30 having control circuitry 32, is provided in FIG. 2. A host computer 34 exchanges information with the disc drive. A disc drive control processor 36, controls the operation of the disc drive 30 in accordance with programming and information stored in dynamic random access memory (DRAM) 38 and non-volatile flash memory 40.

Data to be stored by the disc drive are transferred from the host computer 34 to an interface circuit 42, which includes a data buffer for temporarily buffering the data and a sequencer for directing the operation of a read/write channel 44 and a preamp/driver circuit 46 during data transfer operations. A spindle circuit 48 is provided to control the rotation of the disc 50 by the spindle motor 52.

A servo circuit 54 is provided to control the position of one or more recording heads 56 relative to one or more discs 50 as part of a servo loop established by the head 56, the preamp/driver 46, the servo circuit 54, and the coil 58 that controls the position of an actuator arm. The servo circuit 54 includes a digital signal processor (DSP) which is programmed to carry out two main types of servo operation: seeking and track following.

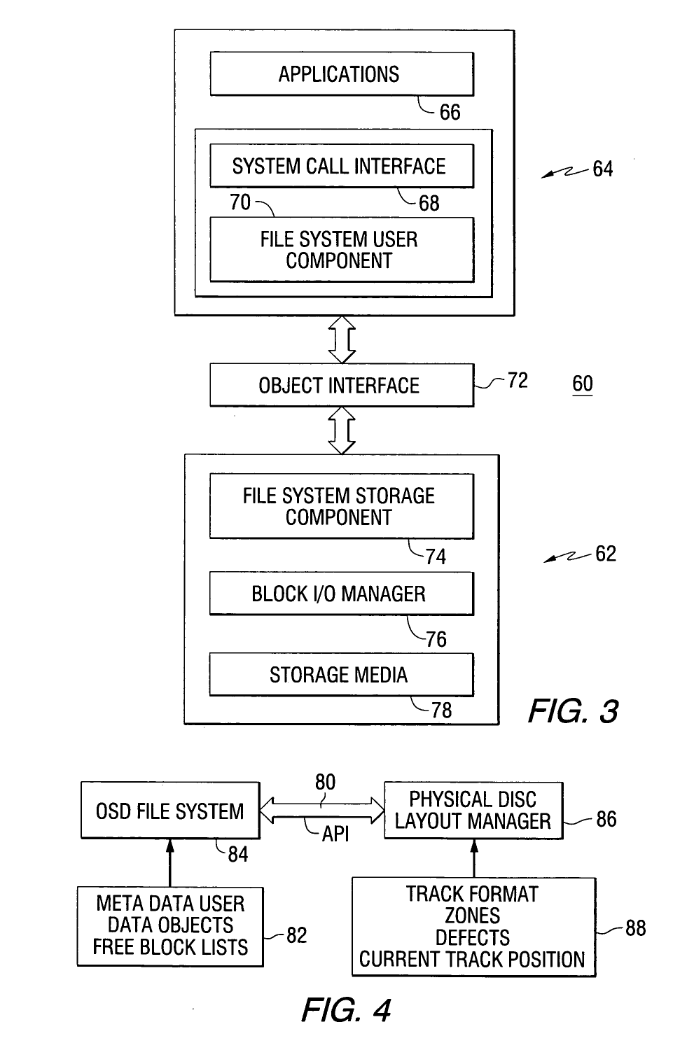

FIG. 3 is a block diagram of an object-based storage system 60 including an OSD disc drive 62 in accordance with the present invention. A host computer 64, which may run numerous applications 66, includes a system call interface 68 and a file system user component 70. The host transmits information through an object interface 72 to the OSD disc drive 62. The disc drive includes a file system storage component 74, a block input/output manager 76, and one or more storage media 78.

FIG. 4 is a block diagram of the OSD and interface firmware layer communication. The OSD layer uses a firmware application program interface (API) 80 for making block requests to the drive. Free block lists 82 are maintained for the metadata and user data objects. The OSD file system 84 provides the OSD layer with candidate starting block locations when new user data blocks are needed to satisfy WRITE, WRITE APPEND, or CREATE commands. A physical disc-layout manager 86 receives the commands and controls the track format, zones, defects, and track position 88.

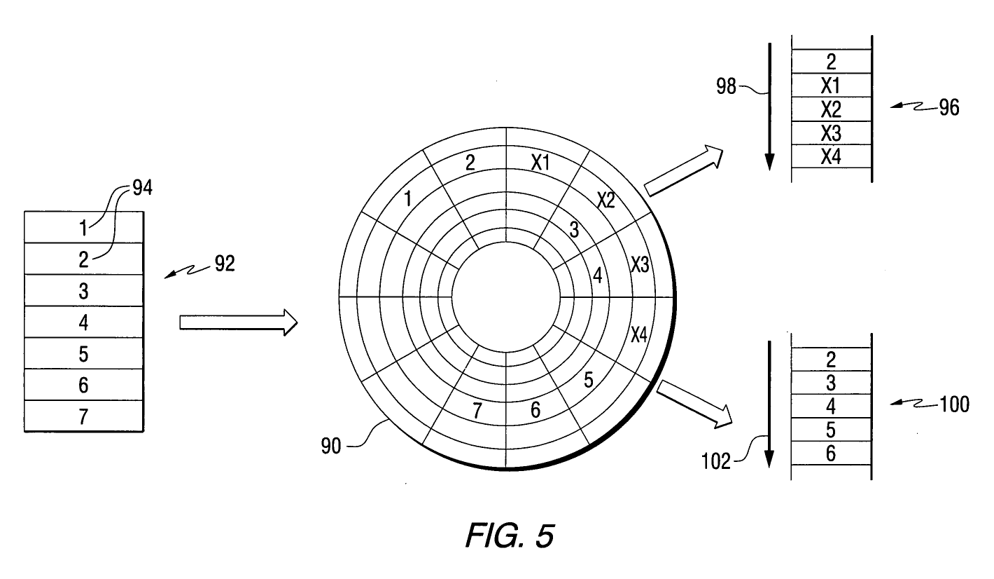

FIG. 5 illustrates how the object-based pre-fetching method of this invention differs from other schemes. FIG. 5 is a schematic representation of a disc 90 and an associated file 92 containing information to be stored on the disc. The file 92 includes data in of a plurality of logical file blocks 94, labeled 1 through 7 in this example. These logical file blocks are mapped to physical disc blocks, as illustrated on disc 90. For a variety of reasons, the logical file blocks may not be mapped to adjacent physical disc blocks.

In previously known (or legacy) pre-fetching schemes, after reading logical block 2, the next consecutive physical blocks X1, X2, X3, etc., would be read and stored to the cache 96. The direction of data access in the cache 96 is illustrated by arrow 98. Blocks X1, X2, X3, etc. contain irrelevant (useless) data with respect to file 92. Therefore, when the next user request arrives, the drive still has to perform a disc access to obtain the remainder of information for file 92. With the object-based pre-fetching, after logical block 2, the drive pre-fetches data corresponding to logical block 3 even though it is on a different section of the drive. Thus a larger portion of the file 92 can be stored in the cache 100. The direction of data access in the cache 100 is illustrated by arrow 102. When the next request arrives, the drive will find data from the relevant blocks already available in the cache and disc access will be avoided. This is accomplished by simply pre-fetching data from the next logical block as described above rather than the next physical block. The disc drive can also employ a prioritization scheme where it pre-fetches data from those logical blocks that are more important for performance than other ones. For example, the prioritization can be between user data and metadata or between different user data types. Different priorities can be set for objects using object attributes. The disc can also apply different priorities for metadata depending on how important they are for the overall performance.

In an OSD device, the initiator is not aware, or does not need to be aware, of the physical block size (perhaps in the future, for video or audio, a superblock may be defined that is an entire track in size), or the physical orientation of the tracks defined during media format. So in an OSD device, pre-fetching is performed not so much in terms of blocks, as compared to a legacy device, but rather, pre-fetching is performed on content. In a legacy pre-fetching operation, the cache is filled with data from as many subsequent blocks after a read operation as the cache can hold. In an OSD pre-fetch operation, the pre-fetch operation would capture as much valid, related content as the cache can hold. Thus an OSD device pre-fetches valid content whereas legacy devices pre-fetch blocks whose content is unknown.

This invention provides a method where the pre-fetching is done based on logical blocks, rather than physical blocks as is done in known pre-fetching schemes. Although what is pre-fetched is content (or data) stored in physical blocks on disc, the decision of what physical blocks to pre-fetch is done based on the next logical block identified for pre-fetching. That is, logical blocks are mapped to physical blocks on the disc.

The next logical block to pre-fetch can be determined in several ways. Since an object is defined as sequence of bytes, one way simply follows the next sequence of bytes in the object. If the host read byte X from this object in the last request, it is very likely that it will read starting byte X+1 in the next request. Based on this, the disc pre-fetches starting from byte X+1 wherever it is located on the disc. It is quite possible that byte X of this object is located at physical block number PB1 and byte X+1 located at physical block number PB2 where PB1 and PB2 are on different parts of the disc (due to fragmentation). For this type of pre-fetching no attribute information is needed. The default definition of the object provides this mechanism.

A second way involves looking at the attributes, so that the disc can interpret the logical layout of the object. For example, if the object is a movie object, the drive can understand where the image frames are stored, where the prediction frames are stored, and where the sound information is stored. Based on the read scenario, it can pre-fetch only the appropriate piece. For example, if it is a fast forward operation, it can skip all the prediction frames and sound information and pre-fetch only the image frames wherever they are on the disc.

A third way involves looking at the attributes, so that the disc can interpret the relation between objects and pre-fetch the objects based on this information. For example, if two objects are read together most of the time, when the first object is requested by the host, the drive can pre-fetch the other object immediately.

A fourth way involves observing how objects are accessed, so that the disc can develop a heuristic for what to pre-fetch next for future requests. This is not possible with block based drives (i.e., today's drives) because the drive has no idea how blocks are related to each other.

This invention provides a smart pre-fetching mechanism at the disc level where previously no information was available about what was being stored/read and how all the pieces are related. With OSD, the disc has this information and this invention takes advantage of it when pre-fetching. Previous pre-fetching mechanisms on disc drives assume that the object data is stored consecutively on the disc and pre-fetches whatever block is next. This invention uses the OSD interface to gather information about the objects either implicitly (by looking at the logical structure, observing access patterns, etc.) or explicitly (by getting explicit hints from the user via attributes).

By using object-based storage technology, this invention provides ways of obtaining this information at the disc level and using it to improve the performance of disc drives by pre-fetching related files/objects.

There are various aspects to the pre-fetching. A first aspect relates to pre-fetching regardless of where/how the data was previously written. A second aspect relates to modifying the write operations so that the current pre-fetching algorithms work better without any changes to them.

This invention includes both static and dynamic pre-fetching. In static pre-fetching, since an OSD drive knows either from attributes or temporal locality that objects are related and will likely be accessed in sequence, then the object data can be written to the media in such a way that a legacy pre-fetch operation will scoop up data from both, or multiple, objects using a single read.

System-level pre-fetching and caching can still be used, as with current disc drives, but the pre-fetching at the disc level will provide improved performance. The present invention is not limited to a particular technique of predicting what to pre-fetch, but provides a mechanism at the disc level where previously known system-level pre-fetching techniques can also be used.

In dynamic pre-fetching, the next object data is speculatively read whether it is proximate to the current read operation or not. This is the case where an object is fragmented and the next fragment is pre-fetched or where several objects are presumed to be related and the data from these objects are pre-fetched speculatively.

This invention also provides a content-aware pre-fetching mechanism for disc drives. A content-aware pre-fetching mechanism allows the disc drives to pre-fetch data based on the type of the data being read. By using object-based storage device technology, the disc drive can use space management information available at the disc level to identify object boundaries and object attributes to gain knowledge about the content of the objects and their relation to other objects. The relation between objects can also be observed and recorded at the disc level without any hints from the applications. The relation information can be used for smart pre-fetching of data from related objects making the data available for users in the cache ahead of the user requests. Examples of such relationship information include: the order in which objects are typically read, byte offset information, different objects that are typically used together by an application (e.g., a movie player that reads from a video object and audio object and interleaves them together before displaying), etc. This type of information could explicitly be specified by the application using object attributes, or the drive can infer this information by observing previous requests. This relationship information can be stored, for example, in a relationship map that can be consulted when making pre-fetching decisions.

The content sensitive mechanism can identify the relationship between different objects and/or between data blocks within a single object by defining and attaching attributes to each object for the applications to specify the relationship, or by observing disc access and identifying the relationship at the disc level. Alternatively, a combination of these approaches can be used. Then the drive uses the relationship information in scheduling and pre-fetching the data from the disc to improve drive performance.

Pre-fetching can occur within an object or between objects. Pre-fetching within an object can simply be the next logical range of bytes, or the next frequently used bytes as determined by a usage pattern. Pre-fetching between objects could be the next logical object or the next frequently used object as determined by a usage pattern or some attribute.

While the invention has been described in terms of several examples, it will be apparent to those skilled in the art that various changes can be made to the described examples without departing from the scope of the invention as set forth in the following claims.

What is claimed is:

1. A method comprising:
storing data for a plurality of objects in a plurality of physical blocks on a storage medium;
using information about the objects to identify logical addresses for the physical blocks used to store the data;
pre-fetching the data from particular ones of the physical blocks based on the identified logical addresses; and
storing the pre-fetched data in a memory.

2. The method of claim 1, wherein the logical addresses are identified based on information contained in attributes of the objects.

3. The method of claim 1, wherein the logical addresses are identified based on priorities of blocks corresponding to the logical addresses.

4. The method of claim 1, wherein the information about the objects includes one or more of:
an indication of file type, an indication of a relationship with other objects, an indication of a preferred order of retrieval, a typical access pattern for the object, an indication of internal fields of the object and the order in which the internal fields are accessed.

5. The method of claim 1, wherein the information about the objects includes:
object boundaries.

6. The method of claim 1, wherein the information about the objects is inferred based on previous requests.

7. The method of claim 1, wherein the logical addresses are identified based on intended usage of the data.

8. An apparatus comprising:
a storage medium for storing data for a plurality of objects in a plurality of physical blocks;
an arm for positioning a recording head adjacent to the storage medium;
a controller for using information about the objects to identify logical addresses for the physical blocks used to store the data, and for pre-fetching the data from particular ones of the physical blocks based on the identified logical addresses; and
a memory for storing the pre-fetched data.

9. The apparatus of claim 8, wherein the logical addresses are identified based on information contained in attributes of the objects.

10. The apparatus of claim 8, wherein the logical addresses are identified based on priorities of blocks corresponding to the logical addresses.

11. The apparatus of claim 8, wherein the information about the objects includes one or more of:
an indication of file type, an indication of a relationship with other objects, an indication of a preferred order of retrieval, a typical access pattern for the object, an indication of internal fields of the object and the order in which the internal fields are accessed.

12. The apparatus of claim 8, wherein the information about the objects includes:
object boundaries.

13. The apparatus of claim 8, wherein the information about the objects is inferred based on previous requests.

14. A method comprising:
storing data for a plurality of objects in a plurality of physical blocks on a storage medium;
observing behavior of the objects to determine relationships between the objects;
using the relationships between the objects, or between different portions of the same object, to pre-fetch that data from particular ones of the physical blocks; and
storing the pre-fetched data in a memory.

15. The method of claim 14, further comprising:
storing the relationships in a relationship map.

16. The method of claim 14, wherein the relationships include one or more of:
an order in which the objects are typically read, byte offset information, and an indication that the objects are typically used together.

17. An apparatus comprising:
a storage medium for storing data for a plurality of objects in a plurality of physical blocks;
an arm for positioning a recording head adjacent to the storage medium;
a controller for observing behavior of the objects to determine relationships between the objects, and for using the relationships between the objects to pre-fetch the data from particular ones of the physical blocks; and
a memory for storing the pre-fetched data.

18. The apparatus of claim 17, wherein the controller stores the relationships in a relationship map.

19. The apparatus of claim 17, wherein the relationships include one or more of:
an order in which the objects are typically read, byte offset information, and an indication that the objects are typically used together.

20. A method comprising:
using attributes or temporal locality to determine that two or more objects are related and will likely be accessed in sequence; and
writing data from the objects to a storage medium in such a way that a traditional pre-fetch operation will pre-fetch the data from the objects using a single read.
